(19) United States
(12) Patent Application Publication
(10) Pub. No.: US 2010/0103490 A1
(43) Pub. Date: Apr. 29, 2010

(54) Optical Information Recording Reproducing Apparatus

(75) Inventors: Kazutaka Noguchi, Tokyo (JP); Takeshi Endo, Osaka (JP); Hiroshi Hatano, Osaka (JP); Tetsuya Noda, Tenri-shi (JP); Hiroyuki Matsuda, Yokohama-shi (JP); Shigeru Yamasaki, Saitama-shi (JP)

Correspondence Address: COHEN, PONTANI, LIEBERMAN & PAVANE LLP, 551 FIFTH AVENUE, SUITE 1210, NEW YORK, NY, 10176, US

(73) Assignee: Konica Minolta Opto, Inc., Tokyo (JP)

(21) Appl. No.: 12/579,571

(22) Filed: Oct. 15, 2009

(30) Foreign Application Priority Data
Oct. 24, 2008 (JP) JP2008-274107

(51) Int. Cl. G03H 1/04; G03H 1/22

(52) U.S. Cl. 359/30

(57) ABSTRACT

In the optical information recording reproducing apparatus that makes a reference light beam to interfere with an information light beam so as to record the information of the information light beam in a recording medium based on a two light beam interference method, or irradiates the reference light beam to a recording medium so as to emit a light beam and reproduces information stored in the recording medium by leading the light beam emitted from the recording medium an the image light receiving element, the optical information recording reproducing apparatus comprises a detector to detect positional deviation of at least one of the reference light beam and the information light beam from a predetermined optical path; and a correcting mechanism to correct the positional deviation based on an output from the detector.

This application is based on Japanese Patent Application No. 2008-274107 filed on Oct. 24, 2008, in Japanese Patent Office, the entire content of which is hereby incorporated by reference.

### BACKGROUND OF THE INVENTION

The present invention relates to an optical information recording reproducing apparatus, especially relates to an optical information recording reproducing apparatus for recording information into a recording medium to record information and reproducing information from a recording medium having recoded information therein by utilizing holography.

In recent years, proposed is a high-density optical information recording reproducing apparatus which employs the principle of holography as disclosed in Patent Document 1. In such an optical information recording reproducing apparatus, at the time of recording, a light flux emitted from a light source is separated by a spatial light modulator SIAM into an information light beam carrying modulated information and a reference light beam and the separated two light beams are irradiated from respective different directions to a recording medium, whereby information can be recorded as interference fringes. On the other hand, at the time of reproducing, the recording medium having recorded information therein is irradiated with the same reference light beam as that at the time of recording and the interference fringes are read out from the recording medium, whereby the recorded information can be reproduced.

Patent documents 1: Japanese Patent Unexamined Publication No. 2008-123627

As mentioned above, since the optical information recording reproducing apparatus employing the principle of holography is adapted to record interference fringes made by both an information light beam and a reference light beam, a relationship between the information light beam and the reference light beam at the time of recording or reproducing becomes very important. More concretely, for example, at the time of reproducing information, in the case of irradiating a reference light beam whose conditions are different from those of a reference light beam used when information was recorded, there is a possibility that information may not be reproduced correctly. Here, as “different conditions” of a reference light beam, for example, difference in the wavelength of a light source, difference in the irradiation angle to a recording medium, difference in the amplitude and phase distribution of a reference light beam and the like may be considered.

In the above examples, the wavelength of a light source, the amplitude and phase distribution of a reference light beam are determined by the characteristic of each semiconductor laser and may be stable to some extent. As compared with the above factors, the irradiation angle of a reference light beam to a record medium tends to comparatively easily change from an initial setting value due to, for example, the influence of vibration and environmental temperature change at the time of conveying or using an optical information recording reproducing apparatus and deterioration with age. On the other hand, in order to use the output intensity of a semiconductor laser as the intensity of an information light beam as far as possible, the diameter of an information light beam may be made equal to the size of the SLM or made slightly larger than it in order to provide allowance. In this case, due to a certain reason, if the optical axis of the optical path of an information light beam is shifted in parallel more than the allowance from the position at the time of manufacture, an information light beam is omitted partially by the SLM. As a result, there is a problem that the information light beam cannot be used effectively.

### SUMMARY OF THE INVENTION

The present invention has been devised in consideration of the above-mentioned problems and an object of the present invention is to provide an optical information recording reproducing apparatus. Namely, even if the optical path of an information light beam or a reference light beam of an optical information recording reproducing apparatus deviates from the position at the time of manufacture, the optical information recording reproducing apparatus according to the present invention can detect the deviation and correct it properly, thereby providing good recording reproducing characteristics.

In order to solve an above-mentioned subject, the optical information recording reproducing apparatus described in Item 1 is provided with a light source; a separating section to separate a light flux from the light source; an optical system to lead one of separated light beams as a reference light beam to a recording medium; a spatial light modulating element to enter another one of the separated light beams and to produce an information light beam; an objective lens to converge the information light beam onto the recording medium, and a image light receiving element to receive a light beam from the recording medium; wherein the optical information recording reproducing apparatus employs a two light beam interference method such that the reference light beam and the information light beam having respective different optical axis are made to interfere with each other so as to record information in the recording medium, thereafter the reference light beam is irradiated to the recording medium, and then a light beam emitted from the recording medium is led to the image light receiving element so as to reproduce information; and the optical information recording reproducing apparatus is characterized by comprising a detector to detect positional deviation of at least one of the reference light beam and the information light beam and a correcting mechanism to correct the positional deviation based on an output from the detector.

According to the present invention, even in the case that deviation from initial setting values takes place in an information light beam and/or a reference light beam entering a recording medium due to, for example, the influence of vibration and environmental temperature change at the time of conveying or using an optical information recording reproducing apparatus and deterioration with age, the detector detects such deviation, and further corrections can be made properly by the correcting mechanism based on the deviation detected by the detector such that the entering position of an information light beam and/or a reference light beam entering a recording medium can be made to a predetermined position, whereby it is possible to provide an optical information recording reproducing apparatus having good recording reproducing characteristics. Here, “corrections” means that one or both of an incident position or an incident angle of an incident light beam into a recording medium is adjusted to a predetermined condition by hands of an operator or automatically.

The optical information recording reproducing apparatus described in Item 2 in the invention described in Item 1 is characterized in that the correcting mechanism includes at least two mirrors arranged on an optical path between the light source and the recording medium and a moving mechanism to change an angle of each of the two mirrors.

According to the present invention, the position of an information light beam and/or a reference light beam entering a recording medium can be adjusted with a simple structure.

The optical information recording reproducing apparatus described in Item 3 in the invention described in Item 1 or 2 is characterized in that on a condition that a recording medium is shifted away from a recording reproducing position, the detector is arranged at a position where the detector is able to receive at least one of the reference light beam and the information light beam.

According to the present invention, by a structure to locate a recording medium away from a recording reproducing position, deviation of an information light beam and/or a reference light beam entering a recording medium can be detected with a simple structure. Here, “a recording reproducing position” means a position where an information light beam and a reference light beam are irradiated to a recording layer of a recording medium.

The optical information recording reproducing apparatus described in Item 4 in the invention described in Item 3 is characterized in that a concave mirror is located on an optical axis of the information light beam at a position opposite to the objective lens across a light converging position of the objective lens so that the image light receiving element receives the information light beam reflected from the concave mirror and detects the deviation of the information light beam, functioning as the detector.

When a concave mirror is located on an optical axis of the information light beam at a position opposite to the objective lens across a light converging position of the objective lens, if the position of the center of a globe of the concave mirror is made to coincide with the focusing position of an objective lens, the information light beam converged by the objective lens is reflected by the concave mirror on the condition that a recording medium is shifted away from the recording reproducing position, and the reflected information light beam returns in the inverse direction, passes through the same objective lens and proceeds along an optical path toward the spatial light modulating element. At this time, the information light beam reflected by the concave mirror is further reflected by a separating element provided between the objective lens and the spatial light modulating element and enters the image light receiving element (preferably a two dimensional sensor) additionally functioning as the detector, whereby the image light receiving element can detect the deviation of the information light beam. Therefore, since it is not necessary to use another detector separately from the image light receiving element, the cost and space of an optical information recording reproducing apparatus can be saved. Further, in this case, if a spatial filter, such as a pinhole is provided between the objective lens and the separating element, the intensity distribution of the information light beam can be detected by the image light receiving element, whereby it is possible to monitor accurately whether the optical axis is located at a right position.

The optical information recording reproducing apparatus described in Item 5 in the invention described in Item 3 is characterized in that a flat mirror is adapted to be located on an optical axis of the information light beam at a light converging position of the objective lens so that the image light receiving element receives the information light beam reflected from the flat mirror and detects the positional deviation of the information light beam, functioning as the detector.

With the structure that a flat mirror is located in place of a recording medium on an optical axis of the information light beam at a focusing position where the information light beam is converged by the objective lens, the information light beam converged by the objective lens is reflected by the flat mirror, returns in the inverse direction, passes through the same objective lens and proceeds along an optical path toward the spatial light modulating element. At this time, the information light beam reflected by the flat mirror is further reflected by a separating element provided between the objective lens and the spatial light modulating element and enters the image light receiving element (preferably a two dimensional sensor) additionally functioning as the detector, whereby the image light receiving element can detect the deviation of the information light beam. Therefore, since it is not necessary to use another detector separately from the image light receiving element, the cost and space of an optical information recording reproducing apparatus can be saved. Further, in this case, if a spatial filter, such as a pinhole is provided between the objective lens and the separating element, the intensity distribution of the information light beam can be detected by the image light receiving element, whereby it is possible to monitor accurately whether the optical axis is located at a right position.

The optical information recording reproducing apparatus described in Item 6 in the invention described in Item 3 is characterized in that the detector is located on an optical axis of the information light beam at a position opposite to the objective lens across a light converging position of the objective lens so that the detector receives the information light beam and detects the deviation of the information light beam.

For example, if a pinhole as a spatial filter is arranged on at least two positions between the light source and the detector, with the structure that the detector is located on an optical axis of the information light beam at a position opposite to the objective lens across a light converging position of the objective lens, the intensity distribution of the information light beam can be detected by the detector, whereby it is possible to monitor accurately whether the optical axis is located at a right position.

The optical information recording reproducing apparatus described in Item 7 in the invention described in any one of Items 1 to 6 is characterized in that the correcting mechanism is arranged on an optical path between the light source and the separating section.

With the structure that the correcting mechanism is arranged at the light source side than the separating section to separate a light flux emitted from the light source into an information light beam and a reference light beam, an adjustment by the correcting mechanism can be conducted for both the information light beam and the reference light beam.

The optical information recording reproducing apparatus described in Item 8 in the invention described in any one of Items 1 to 6 is characterized in that the correcting mechanism is arranged on an optical path of the information light beam between the separating section and the recording medium.

With the structure that the correcting mechanism is arranged on an optical path of the information light beam between the separating section and the recording medium, an adjustment by the correcting mechanism can be conducted for only the information light beam. Therefore, since the reference light beam is not influenced by the adjustment, the position of the information light beam for the reference light beam can be determined promptly.

According to the present invention, even in the case that the optical path of an information light beam and/or a reference light beam is deviated from that at the time of manufacture, the deviation can be detected and corrected properly, whereby it is possible to provide an optical information recording reproducing apparatus having good recording reproducing characteristics.

### BRIEF DESCRIPTION OF THE DRAWINGS

FIG. 1 is a block diagram of an optical information recording reproducing apparatus with a two light flux interference method as a comparative example.

FIG. 2 is a block diagram of an optical information recording reproducing apparatus with a two light flux interference method as a comparative example.

FIG. 3 is a block diagram of an optical information recording reproducing apparatus provided with a correcting mechanism according to a first embodiment.

FIG. 4 is an illustration schematically showing a light receiving surface of a detector PD.

FIG. 5 is a block diagram of an optical information recording reproducing apparatus provided with a correcting mechanism according to a second embodiment.

FIG. 6 is a block diagram of an optical information recording reproducing apparatus provided with a correcting mechanism according to a third embodiment.

FIG. 7 is a block diagram of an optical information recording reproducing apparatus provided with a correcting mechanism according to a fourth embodiment.

FIG. 8 is a block diagram of an optical information recording reproducing apparatus provided with a correcting mechanism according to a fifth embodiment. FIG. 9 is a perspective view of a first movable mirror MM1.

### DETAILED DESCRIPTION OF THE PREFERRED EMBODIMENT

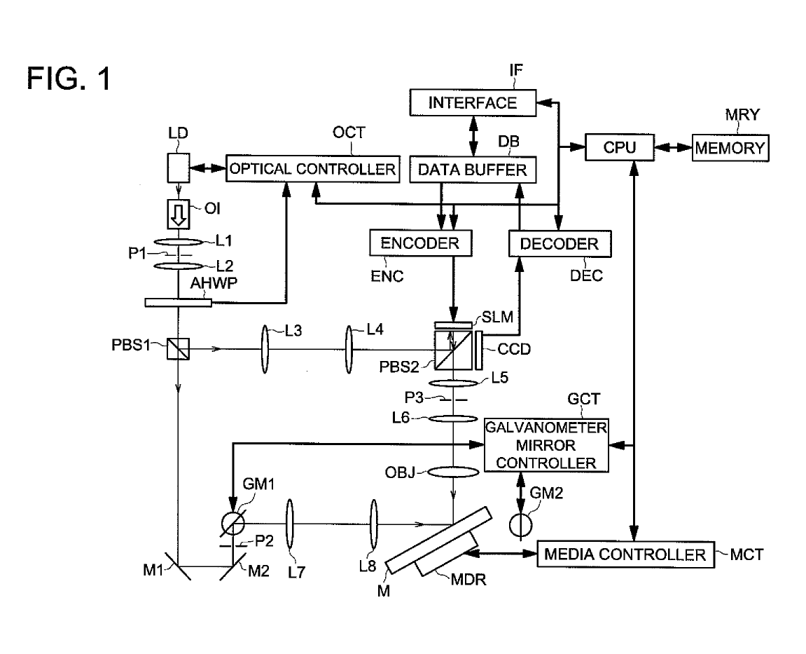

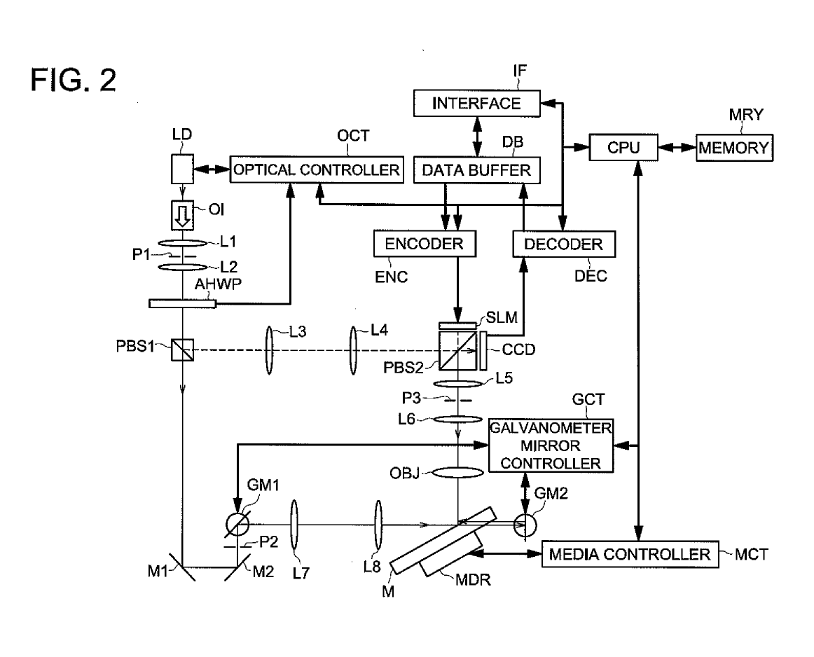

Hereafter, an embodiment of the present invention will be described with reference to drawings. First, the structure, and the recording and reproducing operations of an optical information recording reproducing apparatus on which a correcting mechanism is not mounted, will be explained as a comparative example, and then an optical information recording reproducing apparatus in which a correcting mechanism is added to the above apparatus, will be explained FIGS. 1 and 2 are block diagrams of a optical information recording reproducing apparatus of a two light beam interference type shown as a comparative example. FIG. 1 shows the block diagram at the time of recording, and FIG. 2 shows the block diagram at the time of reproduction. In these block diagrams, a thick solid line shows wiring among devices, a thin solid line shows the optical path of an outgoing light flux, and a dotted line shows that a light flux is blocked.

The optical information recording reproducing apparatus shown in FIGS. 1 and 2 comprises a semiconductor laser LD as a light source and a first polarization beam splitter PBS1 as a separating section which separates a light flux from this semiconductor laser LD into two light fluxes by transmitting a part of the light flux and reflecting another part of it. In the common optical path between the semiconductor laser LD and the first polarization beam splitter PBS1, arranged are an optical isolator OI which allows a light flux from semiconductor laser LD to pass through and prevents a light flux from the reverse direction from passing through; a first lens L1, a first pinhole P1 which functions as a spatial filter to regulate a wave front; a second lens L2; and an active ½ wave plate AHWP. The semiconductor laser LD and the active ½ wave plate AHWP are driven and controlled by an optical controller OCT. The active ½ wave plate AHWPA is made rotatable, for example, by the control of the optical controller OCT so that the active ½ wave plate AHWPA changes the polarization direction of a light flux entering into the first polarization beam splitter PBS1 between a recording time and a reproducing time. Accordingly, the active ½ wave plate AHWPA functions to generate a light flux passing through the first polarization beam splitter PBS1 and a light flux reflecting on it at the time of recording, and functions to generate only a light flux passing through the first polarization beam splitter PBS1 and not to generate a light flux reflecting on it at the reproducing time.

In an exclusive optical path of an information light beam between the first polarization beam splitter PBS1 and a recording medium M for hologram, arranged are a third lens L3; a fourth lens L4; a second polarization beam splitter PBS2; a fifth lens L5, a third pinhole P3 which functions as a spatial filter to regulate a wave front; a sixth lens L6; and an objective lens OBJ. On the other hand, in an exclusive optical path of a reference light beam between the first polarization beam splitter PBS1 and a recording medium M for hologram, arranged are a first mirror M1; a second mirror M2; a second pinhole P2 which functions as a spatial filter to regulate a wave front; a first galvanometer mirror GM1; a seventh lens L7, and a eighth lens L8; and the these members constitute an optical system to guide a reference light beam. Moreover, on an extension line of the exclusive optical path of a reference light beam, a second galvanometer mirror GM2 is arranged at a side opposite to the eighth lens L8 across the recording medium M. The first galvanometer mirror GM1 and the second galvanometer mirror GM2 are driven and controlled by a galvanometer mirror controller GCT. An information light beam and a reference light beam enter so as to cross with each other on a recording medium M. The recording medium M is driven and rotated by a media driving mechanism MD under the control of a media controller MCT.

A CPU controls the optical controller OCT, the galvanometer mirror controller GCT, and the media controller MCT. Moreover, at the time of recording, the CPU converts the data of a data buffer DB by an encoder ENC through an interface IF, and inputs the converted data into a spatial light modulating device SLM as a spatial light modulating element which adjoins one surface of the second polarization beam splitter PBS2. At the time of reproducing, the CPU converts by a decoder DEC the data inputted through a two dimensional sensor CCD (Charge Coupled Devices and Complementary Metal Oxide Semiconductor can be used) as an image light receiving element adjoining another surface of the second polarization beam splitter PBS2. Further, the CPU is adapted to read the data after inputting them into the data buffer DB and to store them in an external memory MRY.

Next, with reference to FIG. 1, operations of the optical information recording reproducing apparatus at the time of recording will be explained. A light flux emitted from the semiconductor laser LD passes through the optical isolator OI, is converged by the first lens L1, passes through the first pinhole P1, passes through the second lens L2, becomes a parallel pencil, and enters into the active ½ wave plate AHWP. Since the active ½ wave plate AHWP is rotated to the recording position, the light flux having passed through the active ½ wave plate AHWP becomes a predetermined polarization condition and enters into the first polarization beam splitter PBS1 which is a separating section. Whereby the light flux is separated into a light flux (a reference light flux) having passed through the first polarization beam splitter PBS1 and a light flux (an information light flux) reflected from on it.

The light flux reflected on first polarization beam splitter PBS1 passes through the third lens L3 and the fourth lens L4, is reflected on the second polarization beam splitter PBS2, and enters into the spatial light modulating device SLM. The light flux having entered into the spatial light modulating device SLM is applied with a two-dimensional modulation corresponding to predetermined information by the function of the spatial light modulating device SLM and is reflected to change a polarization direction. As a result, the light flux with the changed polarization direction passes through the second polarization beam splitter PBS2, further passes through the fifth lens L5, the third pinhole P3, and the sixth lens L6, and is converged onto a recording layer of the recording medium M through the objective lens OBJ.

On the other hand, the light flux having passed through the first polarization beam splitter PBS1 is reflected on the first mirror M1 and the second mirror M2 successively, and passes through the second pinhole P2. Thereafter, the light flux is reflected on first galvanometer mirror GM1, passes through the seventh lens L7 and the eighth lens L8, and then is irradiated onto a recording layer of the recording medium M. At this time, the information light flux and the reference light flux are irradiated to the same position to cause interference fringes, whereby information can be recorded. Further, with the adjustment of the angle of the first galvanometer mirror GM1 by the galvanometer mirror controller GCT, a relative angle between the information light flux and the reference light flux is changed, whereby information can be recorded multiply.

Next, with reference to FIG. 2, the operations of the optical information recording reproducing apparatus at the reproducing time will be explained. A light flux emitted from the semiconductor laser LD passes through the optical isolator OI, is converged by the first lens L1, passes through the first pinhole P1, passes through the second lens L2, becomes a parallel pencil, and enters into the active ½ wave plate AHWP. Since the active ½ wave plate AHWP is rotated to the reproducing position, the light flux having passed through the active ½ wave plate AHWP becomes a predetermined polarization condition and enters into the first polarization beam splitter PBS1 which is a separating section. Whereby the light flux is made only a light flux (a reference light flux) having passed through the first polarization beam splitter PBS1.

The light flux having passed through the first polarization beam splitter PBS1 is reflected on the first mirror M1 and the second mirror M2 successively, and passes through the second pinhole P2. Thereafter, the light flux is reflected on first galvanometer mirror GM1, passes through the seventh lens L7 and the eighth lens L8, and then is irradiated onto a recording layer of the recording medium M, and passes through a position where information is recorded.

The light flux having passed through the recording medium M is reflected on the second galvanometer mirror GM2, and re-enters into the recording medium M. The re-entering angle of the reflected light flux into the recording medium is controlled by the firs galvanometer mirror GM1 and the second galvanometer mirror GM2.

The light flux re-entered into the recording medium M becomes a light flux with a pattern corresponding to the interference fringes currently recorded on the recording layer of the recording medium M. The pattern light flux further passes through the objective lens OBJ, the sixth lens L6, the third pinhole P3, and the fifth lens L5, is reflected on the polarization beam splitter PBS2, and enters into the light receiving surface of the two dimensional image sensor CCD.

In this way, the pattern light flux having entered into the light receiving surface of the two dimensional image sensor CCD is converted into electrical signals by its image-to-signal conversing function, whereby the two-dimensional pattern information corresponding to the information currently recorded on the recording medium M is reproduced.

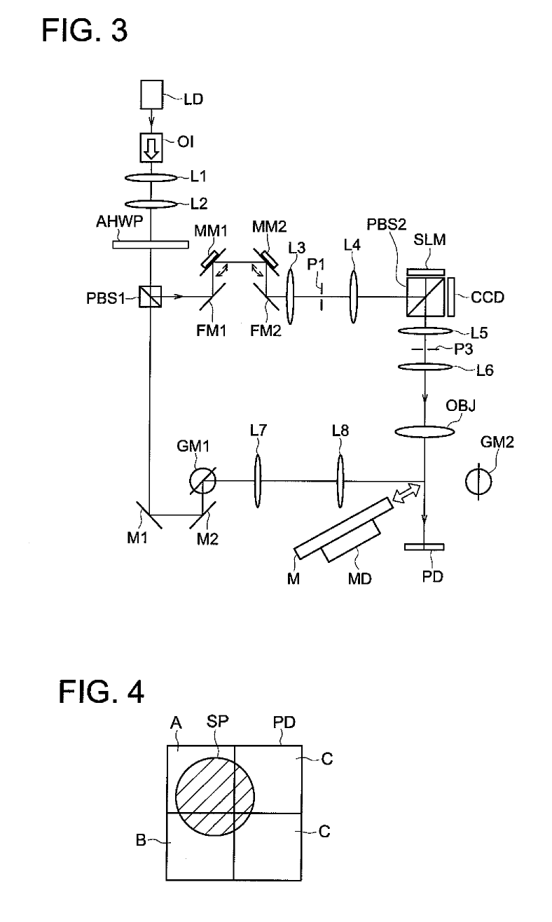

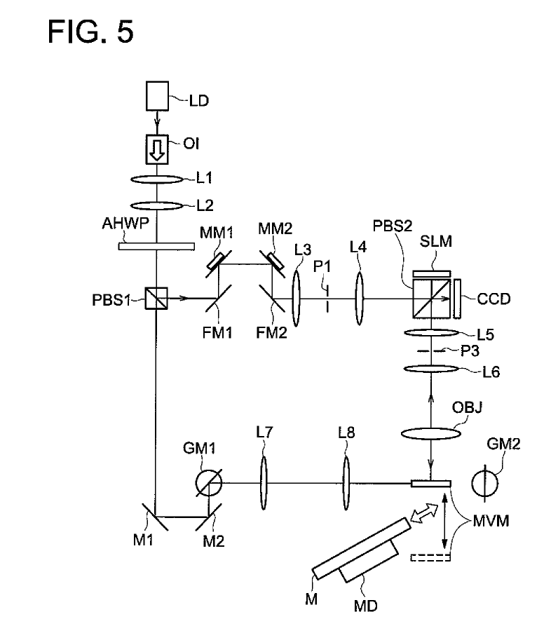

FIG. 3 is a block diagram of the optical information recording reproducing apparatus according to the first embodiment provided with a correcting mechanism and the like, and unlike FIGS. 1 and 2, the control device is omitted in FIG. 3. FIG. 4 is an illustration showing schematically a light receiving surface of a detector PD. In FIG. 3, a recording medium M can be shifted away together with a media driving mechanism MD in one body along a linear guide (not shown in the drawings) from the recording and reproducing position shown in FIGS. 1 and 2 to the shifted-away position shown in FIG. 3. On the condition that the recording medium M is shifted away, a detector PD, such as a quarter-divided light receiving element, is arranged at an extended position of the optical path of an information light beam (the back side of the recording medium M at the time of recording or reproducing). Since the back side of the recording medium M is made to a dead space in many cases in the optical information recording reproducing apparatus, a possibility that the mounting of the detector PD causes a problem is low. However, the detector PD may be made dismountable and may be mounted only at the time of adjustment. Here, a first pinhole P1 is provided between the third lens L3 and the fourth lens L4.

Furthermore, unlike the structures of FIGS. 1 and 2, a correcting mechanism is provided between the first polarization beam splitter PBS1 and the third lens L3 (within the optical path of an information light beam) such that a first fixed mirror FM1, a first movable mirror MM1, a second movable mirror MM2, and a second fixed mirror FM2 are arranged in this order between them. As well as other fixed optical elements, the first fixed mirror FM1 and the second fixed mirror FM2 are fixed on a frame (not shown in the drawings). On the other hand, the first movable mirror MM1 and the second movable mirror MM are made rotatable around an axis in a direction vertical to the sheet surface in FIG. 3 through a movable device shown in FIG. 9 for the frame (not shown in the drawings), in addition, preferably around an axis in a direction perpendicular to the direction vertical to the sheet surface. At the time of recording, a light flux proceeding from the first polarization beam splitter PBS1 to the third lens L3 is reflected on the first fixed mirror FM1, the first movable mirror MM1, the second movable mirror MM2, and the second fixed mirror FM2 respectively and returns to the original optical path. Therefore, the recording of information and the measuring of deviation are not interrupted by the structure that the correcting mechanism is inserted into the optical path.

FIG. 9 is a perspective view of the first movable mirror MM1. Here, the second movable mirror MM2 also has the similar structure. In FIG. 9, the first movable mirror MM1 comprises a plate-shaped base BS fixed to a frame (not shown in the drawings); a plate-shaped stage ST arranged in parallel to the base B5 on the condition that the stage ST is separated from the base BS; a prism mirror PM mounted on stage ST, and three piezoelectric elements PZ connecting the base BS with the stage ST. A slant face of the prism mirror PM is made to a mirror surface (mirror) to reflect light beams. The tree piezoelectric elements PZ are arranged so as to position at the apexes of a virtual triangle for the base BS and the stage ST, and are separately extensible or retractable by being supplied with electric power from a drive unit (not shown in the drawings). Here, with a technique to set the extending amount or the retracting amount of each of the three piezoelectric elements PZ to predetermined values, the stage ST can be arbitrarily slanted with an angle in the direction of X and the direction of Y to the base BS along an XY plane, whereby the inclination of the mirror surface of the prism mirror PM can be adjusted in a three dimensional way. Therefore, the angle of emitted light beams can be arbitrarily changed for the angle of incident light beams which enter the mirror surface. Instead of the piezoelectric element PZ, a voice coil motor or SIDM may be used. A movable device is constituted by the base BS, the stage ST, and the piezoelectric element PZ.

An explanation will be made on deviation detection and a deviation adjustment for a light flux in the optical information recording reproducing apparatus according to the first embodiment. At the time of detecting and adjusting deviation, a recording medium M is shifted away from the recording and reproducing position. On this condition, if a light flux is emitted from a semiconductor laser LD, the light flux proceeds along an optical path explained with reference to FIG. 1, and an information light beam is converged through an objective lens OBJ. At this time, since a recording medium M is shifted away from the recording and reproducing position, the information light beam reaches a detector PD without being interrupted by this. Further, since two pinholes P1 and P3 are arranged on the optical path of the information light beam, the position of a spot SP converged by the objective lens OBJ deviates clearly on a light receiving surface of the detector PD in accordance with the principle of autocollimator, whereby detection can be conducted with high accuracy.

The light receiving surface of the detector PD is divided into four regions in the shape of the Japanese character [symbol] as shown in FIG. 4. Here, when a spot converged by the objective lens OBJ is formed at the center of the light receiving surface, an amount of light received by each of the four regions is represented by A, B, C and D respectively. Further, X and Y are defined by the following formulas.

X=(A+C)−(B+D)

Y=(A+B)−(C+D)

When X and Y are calculated by the above formulas, it is understood that the larger, the absolute value of each of X and Y is, the more, the position of the converged spot deviates. Then, in order to make the center of a converged spot to coincide with the center of the light receiving surface, a deviation adjustment is conducted manually by an operator or automatically in such a way that the angle of the first movable mirror MM1 or the second movable mirror MM is changed so as to make the value of each of X and Y to become close to zero (X=0, Y=0). As a result, an information light beam can be converged at a predetermined position on a recording medium. Therefore, for example, the deviation adjustment was conducted at the time of the factory shipment of an optical information recording reproducing apparatus, and thereafter, in the case that an information light beam deviates from initial setting values due to the influence of vibration and a change of environmental temperature at the time of conveying and using the optical information recording reproducing apparatus and deterioration with age, if the deviation adjustment is conducted again, recording and/or reproducing information can be conducted appropriately stably for a long period of time. Here, in this embodiment, during the deviation detection, a reference light beam is also emitted. However, since the optical path of the reference light beam is different from that of an information light beam for the deviation detection, the reference light beam is not mixed with the information light beam. Accordingly, there is no special problem. However, in order to avoid any unnecessary stray light beam, a shutter and the like may be provided after a separating section. With this, a reference light beam is blocked during the deviation detection. Further, with the application of the similar structure, the deviation of a reference light beam can be also detected and corrected.

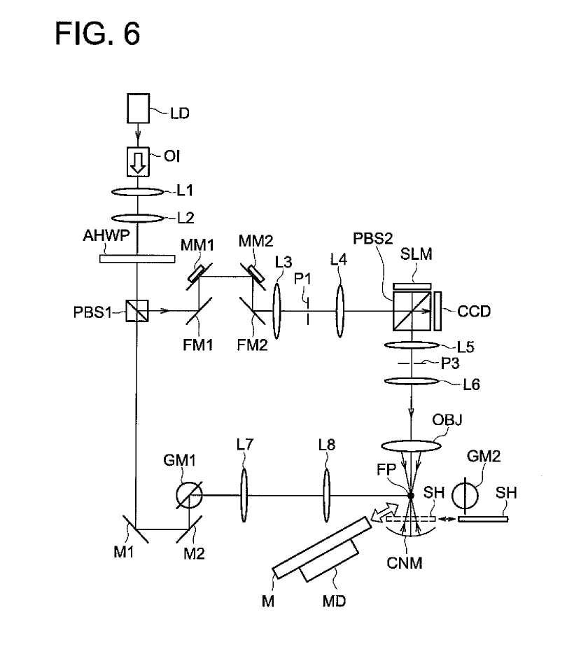

FIG. 5 is a block diagram of the optical information recording reproducing apparatus according to the second embodiment provided with a correcting mechanism and the like, and unlike FIGS. 1 and 2, the control device is omitted in FIG. 5. In FIG. 5, a recording medium M can be shifted away together with a media driving mechanism MD in one body along a linear guide (not shown in the drawings) from the recording and reproducing position shown in FIGS. 1 and 2 to the shifted-away position shown in FIG. 3. In the vicinity of the media driving mechanism MD, a movable flat mirror MVM is arranged so as to be able to shift between a waiting position and a measuring position along a guide rail (not shown in the drawings) or by a link mechanism. When a recording medium M is located at the recording and reproducing position, the movable flat mirror MVM is waiting at the waiting position (indicated with a dotted line in FIG. 5) located at the opposite side (the back side of the recording medium M) to the objective lens OBJ across the recording medium M. On the other hand, when the recording medium M is shifted away from the recording and reproducing position or located at the shifted-away position, the movable flat mirror MVM is adapted to shift to the measuring position (indicated with a solid line in FIG. 5) where a light converging position of the objective lens is located on a reflecting surface.

As with the embodiment shown in FIG. 3, in the second embodiment, the first pinhole P1 is also provided between the third lens L3 and the fourth lens L4, and a correcting mechanism is provided between the first polarization beam splitter PBS1 and the third lens L3 (within the optical path of an information light beam) such that a first fixed mirror FM1, a first movable mirror MM1, a second movable mirror MM2, and a second fixed mirror FM2 are arranged in this order between them.

An explanation will be made on deviation detection and a deviation adjustment for a light flux in the optical information recording reproducing apparatus according to the second embodiment. At the time of detecting and adjusting deviation, a recording medium M is shifted away from the recording and reproducing position, and the movable flat mirror MVM is shifted to the measuring position. On this condition, if a light flux is emitted from a semiconductor laser LD, an information light beam is converged through an objective lens as explained with reference to FIG. 1. At this time, since the reflecting surface of the movable flat mirror MVM is located at the light converging position in place of the recording medium M, the information light beam is reflected on the movable flat mirror MVM and returns again along the optical path of the information light beam. Further, the information light beam passes through the objective lens OBJ, the sixth lens L6, the pinhole P3, and the fifth lens L5, is reflected on the second polarization beam splitter PBS2, and then enters a light receiving surface of a two dimensional image sensor CCD additionally serving as a detector, whereby the deviation of the information light beam in the two dimensional direction can be detected. Furthermore, the deviation adjustment is conducted in such a way that the angle of the first movable mirror MM1 or the second movable mirror MM2 is changed so as to eliminate the deviation. According to this embodiment, since the light receiving surface of a two dimensional image sensor CCD for reading information is used also as the detector for deviation detection, the reduction of the number of components and the reduction of costs can be attained.

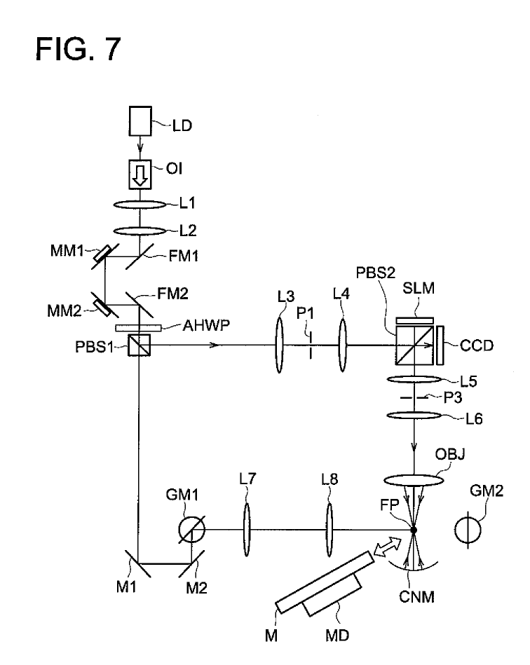

FIG. 6 is a block diagram of the optical information recording reproducing apparatus according to the third embodiment provided with a correcting mechanism and the like, and unlike FIGS. 1 and 2, the control device is omitted in FIG. 6. In FIG. 6, a recording medium M can be shifted away together with a media driving mechanism MD in one body along a linear guide (not shown in the drawings) from the recording and reproducing position shown in FIGS. 1 and 2 to the shifted-away position shown in FIG. 6. On the condition that the recording medium M is shifted away, a concave mirror CNM is arranged and fixed on a frame (not shown in the drawings) at an extended position of the optical path of an information light beam (the back side of the recording medium M at the time of recording or reproducing). Here, the focusing position of the concave mirror CNM is made to coincide with focusing position FP of the objective lens OBJ. Furthermore, in the vicinity of the media driving mechanism MD, a shutter SH is arranged so as to be able to shift between a waiting position and a blocking position along a guide rail (not shown in the drawings) or by a link mechanism. When a recording medium M is located at the recording and reproducing position, the shutter is shifted to the blocking position (indicated with a dotted line in FIG. 6) between the focusing position FP of the objective lens and the concave mirror CNM so that a reference light beam which have passed through a recording medium M and reflected on the concave mirror CNM at the recording or reproducing time is prevented from becoming stray light. On the other hand, when the recording medium M is shifted to the shifted-away position, the shutter SH is adapted to is shifted to the waiting position (indicated with a solid line in FIG. 6) at the side so that a light beam converged by the objective lens OBJ is not prevented from reaching the concave mirror CNM.

As with the embodiment shown in FIG. 3, in the third embodiment, the first pinhole P1 is also provided between the third lens L3 and the fourth lens L4, and a correcting mechanism is provided between the first polarization beam splitter PBS1 and the third lens L3 (within the optical path of an information light beam) such that a first fixed mirror FM1, a first movable mirror MM1, a second movable mirror MM2, and a second fixed mirror FM2 are arranged in this order between them.

An explanation will be made on deviation detection and a deviation adjustment for a light flux in the optical information recording reproducing apparatus according to the third embodiment. At the time of detecting and adjusting deviation, a recording medium M is shifted away from the recording and reproducing position and the shutter SH is shifted away from the blocking position. On this condition, if a light flux is emitted from a semiconductor laser LD, an information light beam is converged toward a focusing position FP through an objective lens OBJ as explained with reference to FIG. 1, and after having passed through it, the information light beam spreads. Then, when the spreading information light beam is reflected by the concave mirror CMN, the information light beam passes again through the focusing position FP and is converted into a parallel light beam by the objective lens. Successively, the information light beam returns again along the optical path of the information light beam, passes through the objective lens OBJ, the sixth lens L6, the pinhole P3, and the fifth lens L5, is reflected on the second polarization beam splitter PBS2, and then enters a light receiving surface of a two dimensional image sensor CCD additionally serving as a detector, whereby the deviation of the information light beam in the two dimensional direction can be detected. Furthermore, the deviation adjustment is conducted in such a way that the angle of the first movable mirror MM1 or the second movable mirror MM2 is changed so as to eliminate the deviation. According to this embodiment, with the structure to provide a space filter such as a the third pin hole P3 and the like between the second polarization beam splitter PBS2 and the objective lens OBJ, the intensity distribution of an information light beam on the light receiving surface of the two dimensional image sensor CCD is detected so that it become possible to detect properly whether or not the optical axis is located at a right position.

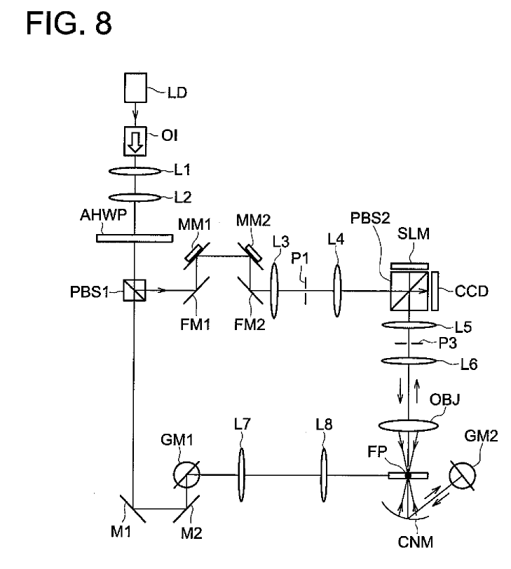

FIG. 7 is a block diagram of the optical information recording reproducing apparatus according to the fourth embodiment provided with a correcting mechanism and the like, and unlike FIGS. 1 and 2, the control device is omitted in FIG. 7. In this embodiment, unlike the embodiment shown in FIG. 6, a correction mechanism in which a first fixed mirror FM1, a first movable mirror MM1, a second movable mirror MM2, and a second fixed mirror FM2 are arranged in this order is not provided between the first polarization beam splitter PBS1 and the third lens L3 (within the optical path of an information light beam), but is provided at a position on the common optical path between the second lens L2 and the first polarization beam splitter PBS1 (the position is not limited to this exemplified position as far as the position is located to the light source side than the separating section). Since the other points are the same as the structure of FIG. 6, the explanation is omitted (a shutter SH is omitted in FIG. 7).

According to this embodiment, if the angle of the mirror of first movable mirror MM1 or the second movable mirror MM2 is changed based on the deviation detected by the two dimensional image sensor CCD, not only an information light beam but also a reference light beam is shifted, namely, the adjustment for a reference light beam and an information light beam can be conducted simultaneously by one adjustment.

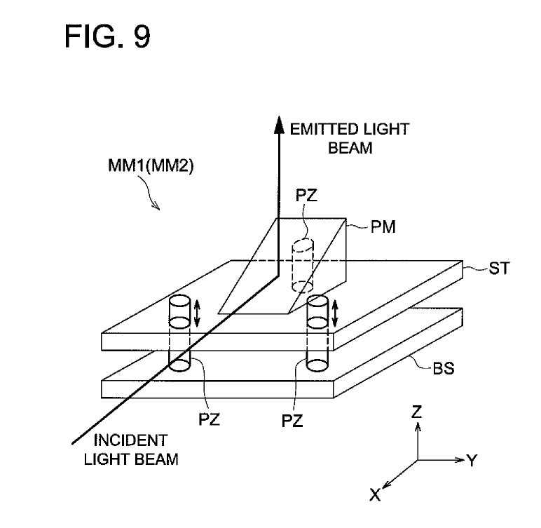

FIG. 8 is a block diagram of the optical information recording reproducing apparatus according to the fifth embodiment provided with a correcting mechanism and the like, and unlike FIGS. 1 and 2, the control device is omitted in FIG. 8. In this embodiment, unlike the embodiment shown in FIG. 6, a concave mirror is slanted and a shutter is not provided. Since the other points are the same as the structure of FIG. 6, the explanation is omitted (a recording medium M is omitted in FIG. 8).

At the time of detecting and adjusting deviation in this embodiment, the second galvanometer mirror GM2 is rotated from the position opposing the recording medium to the position opposing the concave mirror CNM. On this condition, if a light flux is emitted from a semiconductor laser LD, an information light beam is converged toward a focusing position PP through an objective lens OBJ as explained with reference to FIG. 1, and after having passed through it, the information light beam spreads. Then, when the spreading information light beam is reflected and collimated on the concave mirror CMN, the parallel information light beam proceeds toward the second galvanometer mirror GM2, is reflected on the second galvanometer mirror GM2, and is further reflected again and converged by the concave mirror CMN. Successively, the converged information light beam passes again through the focusing position FP and is converted into the parallel information light beam. Then, the parallel information light beam returns again along the optical path of the information light beam, passes through the objective lens OBJ, the sixth lens L6, the pinhole P3, and the fifth lens L5, is reflected on the second polarization beam splitter PBS2, and then enters a light receiving surface of a two dimensional image sensor CCD additionally serving as a detector, whereby the deviation of the information light beam in the two dimensional direction can be detected. Furthermore, the deviation adjustment is conducted in such a way that the angle of the first movable mirror MM1 or the second movable mirror MM2 is changed so as to eliminate the deviation.

Here, after a light beam has passed through a recording medium M at the time of recording or reproducing information, reached the concave mirror CNM and was reflected to the second galvanometer mirror GM2 side, there is a possibility that the light beam becomes stray light. However, according to this embodiment, since the second galvanometer mirror GM2 is located to oppose a recording medium at the recording or reproducing time, if unnecessary light from the concave mirror CNN proceeds to the second galvanometer mirror GM2, the unnecessary light is blocked at there. Therefore, it is possible to prevent effectively stray light from erroneously being detected by the two dimensional image sensor CCD. Therefore, it is desirable to apply a light shielding treatment, such as a black coating, to an external surface of the second galvanometer mirror GM2 except a reflecting surface.

What is claimed is:

1. An optical information recording reproducing apparatus, comprising:
a light source to emit a light flux;
a separating section to separate the light flux from the light source into at least a first light beam and a second light beam;
an optical system to lead the first light beam as a reference light beam to a recording medium;
a spatial light modulating element to provide information to the second light beam so as to produce an information light beam;
an objective lens to converge the information light beam onto the recording medium; and
an image light receiving element to receive a light beam emitted from the recording medium;
wherein the optical information recording reproducing apparatus makes the reference light beam to interfere with the information light beam so as to record the information of the information light beam in the recording medium based on a method of making two light beam having respective different optical axis to interfere with each other, or irradiates the reference light beam to a recording medium so as to emit a light beam and reproduces information stored in the recording medium by leading the light beam emitted from the recording medium to the image light receiving element; and
the optical information recording reproducing apparatus further comprising:
a detector to detect positional deviation of at least one of the reference light beam and the information light beam from a predetermined optical path; and
a correcting mechanism to correct the positional deviation based on an output from the detector.

2. The optical information recording reproducing apparatus described in claim 1, wherein the correcting mechanism includes at least two mirrors arranged on an optical path between the light source and the recording medium and a moving mechanism to change an angle of each of the two mirrors.

3. The optical information recording reproducing apparatus described in claim 1, wherein the recording medium is adapted to be shifted away from or to a recording reproducing position, and wherein on a condition that the recording medium is shifted away from the recording reproducing position, the detector is arranged at a position where the detector is able to receive at least one of the reference light beam and the information light beam.

4. The optical information recording reproducing apparatus described in claim 3, wherein a concave mirror is located on an optical axis of the information light beam at a position opposite to the objective lens across a light converging position of the objective lens so that the image light receiving element receives the information light beam reflected from the concave mirror and detects the positional deviation of the information light beam, functioning as the detector.

5. The optical information recording reproducing apparatus described in claim 3, wherein a flat mirror is adapted to be located on an optical axis of the information light beam at a light converging position of the objective lens so that the image light receiving element receives the information light beam reflected from the flat mirror and detects the positional deviation of the information light beam, functioning as the detector.

6. The optical information recording reproducing apparatus described in claim 3, wherein the detector is located on an optical axis of the information light beam at a position opposite to the objective lens across a light converging position of the objective lens so that the detector receives the information light beam and detects the positional deviation of the information light beam.

7. The optical information recording reproducing apparatus described in claim 1, wherein the correcting mechanism is arranged on an optical path between the light source and the separating section.

8. The optical information recording reproducing apparatus described in claim 1, wherein the correcting mechanism is arranged on an optical path of the information light beam between the separating section and the recording medium.
